(19) United States
(12) Patent Application Publication
(10) Pub. No.: US 2004/0258112 A1
(43) Pub. Date: Dec. 23, 2004

(54) Laser power controlling method and laser power controller

(75) Inventor: Shigeru Furumiya, Hyogo (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 10/817,798

(22) Filed: Apr. 6, 2004

(30) Foreign Application Priority Data
Apr. 8, 2003 (JP) P2003-103946

(51) Int. Cl. H01S 3/00

(52) U.S. Cl. 372/38.01; 372/38.02; 372/38.07

(57) ABSTRACT

The laser power controlling method includes calculating an initial average value of the light intensity of the pulsed emission of the laser, calculating an average value of the light intensity of the pulsed emission of the laser for each time and then calculating the difference between the value and the initial average value, and controlling the driving current of the laser according to the difference.

### BACKGROUND OF THE INVENTION

1. Field of the Invention

The present invention relates to a control of laser power.

2. Related Art

Laser is used as the light source of an optical disc device practically used for an auxiliary storage in a computer or the like. In general, individual laser elements have large differences in their characteristics, and the relationship between input current and output light power is not constant with an influence of temperature change and aging of the laser element. Therefore, an optical disk device is so configured as to obtain desired laser power at any time using a power control of the feedback type which controls the output to be constant while monitoring the emitted power of the laser. Further, in a recordable optical disc device, it is required to control the power in the state of pulse-emitting the laser beam corresponding to record data, and various methods have been proposed.

The conventional laser power controlling methods in the pulse-emitting state are roughly grouped in two types. One is a method in which a test emission is performed when data is not being written to thereby determine and store a current value required for pulsed emission, and when writing data, the writing is continued while keeping the stored current value. This is called a test emission method (see, for example, Japanese Patent No. 2861625). Another one is a method in which a high-speed sample and hold circuit extracts a section in the record data, where the intensity is locally constant, to thereby discretely perform a power control when writing. This is called a sample and hold method (see, for example, Japanese Laid-open Patent Publication No. H9-171631).

In the aforementioned, two conventional methods, there are following problems, respectively.

First, with the test emission method, although the laser current is held for a period of writing data, the laser temperature will rise when the data is written if the data is written continuously for a long period, whereby the emission intensity will change, even if the current value is held constant. To solve this problem, there is a method to suppress the intensity change to the negligible level by adopting a track format in which an area (gap) for test emission is provided at every fixed interval of the recording track so as to cause the test emission at every fixed time interval. In this case, however, the recording area is reduced by providing the test emission area, and the capacity efficiency of the recording medium drops.

With the sample and hold method, on the other hand, if the frequency of the record data is increased in order to improve writing rate, the frequency characteristic of the emission intensity monitor may be insufficient. In addition, the high-speed sample and hold circuit requires extremely high response performance, which causes an increase in the cost of the components in use.

### SUMMARY OF THE INVENTION

It is therefore an object of the present invention to provide a method of continuously controlling, at any time, the power of a laser in the pulse emitting state while writing data, without using a high-speed sample and hold circuit.

A laser power controlling method according to the present invention includes the steps of:

calculating the initial average value of the light intensity of a pulsed emission of a laser;

calculating the value of the light intensity of the pulsed emission of the laser for each time, and calculating a difference between the value and the initial average value; and

controlling the driving current of the laser according to the difference.

The step of calculating the initial average value of the light intensity of the pulsed emission of the laser may include the steps of:

providing a predetermined driving current with the laser so as to cause a pulsed emission;

receiving the pulsed emission of the laser, and detecting the light intensity; and

averaging the light intensity, and calculating the initial average value of the light intensity of the pulsed emission.

The step of controlling the driving current of the laser may include the steps of:

temporally integrating the difference, and outputting an integral value; and

providing the driving current obtained by summing the predetermined driving current and a compensation current corresponding to the integral value.

In the step of providing the predetermined driving current so as to cause the pulsed emission, the pulsed emission is caused by applying the driving current obtained by summing a pulse current in which the intensity thereof is modulated, and a bias current having a constant current value.

The compensation current may be a current for adjusting the bias current.

Further, a step of setting the predetermined driving current for pulse-emitting the laser may be included.

In the step of setting the predetermined driving current may include the steps of:

providing a current to the laser in a predetermined test emission pattern; receiving a laser emission of the laser, and detecting the light intensity thereof; and

setting an initial value of the current source of the predetermined driving current according to a current value where the light intensity comes to a predetermined monitor value.

A laser power controller according to the present invention includes:

a laser driving unit which applies a driving current to a laser for causing a pulsed emission on the laser;

a light receiving unit which receives the pulsed emission of the laser and detecting the light intensity thereof for each time;

an initial average value calculating unit which calculates an initial average value of the light intensity of the pulsed emission of the laser;

a computing unit which calculates a difference between the value of the light intensity for each time and the initial average value; and

a control unit which controls the driving current according to the difference.

The initial average value calculating unit, for example, provides a predetermined driving current from the laser driving unit to the laser so as to cause a pulsed emission, receives the pulsed emission of the laser in the light receiving unit so as to detect the light intensity, and averages the light intensities so as to calculate the initial average value of the light intensity of the pulsed emission.

The control unit temporally integrates the difference and outputs an integral value, and provides to the laser a driving current obtained by summing the predetermined driving current and a compensation current corresponding to the integral value so as to control the driving current.

The laser driving unit preferably includes:

a bias current source; and

a pulse current source which outputs a pulse current in which the intensity thereof is modulated.

Further, a driving current setting unit which sets the predetermined driving current for causing the pulsed emission of the laser may be included.

According to the laser power controlling method and the laser power controller according to the present invention, a difference between the initial average value of the light intensity of the pulsed emission which has been calculated beforehand and the value of the light intensity of the pulsed emission for each time is calculated, and the driving current of the laser is controlled according to the difference. Thus, even when a drop in the laser power or the like is caused by the heat generated in the laser, the same laser power can be obtained by controlling the driving current. Therefore, the laser power controlling method and the laser power controller according to the present invention can be used in optical disc devices in which the writing rate and the capacity are extremely high.

### BRIEF DESCRIPTION OF THE DRAWINGS

The present invention will become readily understood from the following description of preferred embodiments thereof made with reference to the accompanying drawings, in which like parts are designated by like reference numeral and in which:

FIG. 1 is a partial schematic diagram of an optical disc device including a laser power controller according to an embodiment of the present invention;

FIG. 2 is a block diagram of the laser power controller according to the embodiment of the present invention;

FIG. 3 is a chart of an operational characteristic of the laser;

FIG. 4 is a signal waveform chart according to a test emission pattern;

FIG. 5 is a flowchart for setting an initial value of each current source of the driving current using the test emission pattern;

FIG. 6A is a chart of changes in the laser power due to the temperature;

FIG. 6B is a chart of changes of the temperature of the laser;

FIG. 7 is a flowchart of a laser power controlling method according to the embodiment of the present invention;

FIG. 8 is a signal waveform chart of timings for obtaining the initial average value of the light intensity of the pulsed emission; and

FIG. 9 is a signal waveform chart of the relationship between a monitor waveform and an integral value.

### DETAILED DESCRIPTION OF THE PREFERRED EMBODIMENTS

A laser power controller and a laser power controlling method according to an embodiment of the present invention will be described below with reference to the drawings. In the drawings, the same reference numerals are given to the components having the same function.

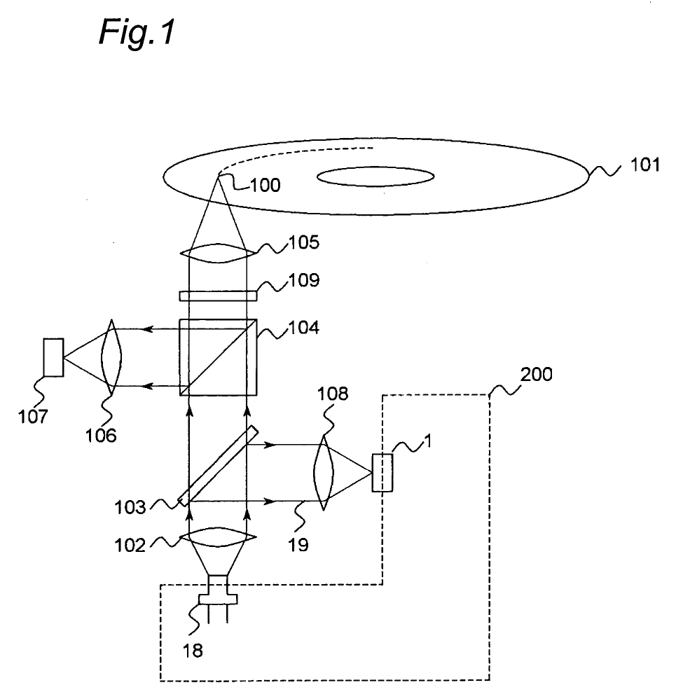

FIG. 1 is a partial schematic diagram showing an optical disc device having a laser power controller 200 according to an embodiment of the present invention. The optical disc device reads data written in an optical disc 101 by a convergent beam 100, or writes predetermined data into the optical disc 101. The reading operation of data will be explained. The laser beam emitted from the laser 18 is collimated into parallel beams by a collimate lens 102, and passed through a transparent mirror 103, a polarized beam splitter 104 and a quarter-wavelength plate 109, then converted into a convergent beam 100 by a object lens 105. The beam emitted to the optical disk 101 is condensed on the information recording surface. The beam reflected at the information recording surface of the optical disc 101 passes through the quarter-wavelength plate 109 again, whereby the polarized direction of the reflected beam is changed. Then, the reflected beam reaches the polarized beam splitter 104. The polarized beam splitter 104 only reflects a reproduced beam to thereby extracts it. Consequently, the extracted beam is led to a photodetector 107 through a condenser lens 106. A signal detected by the photodetector 107 is reproduced as a signal of the read data. Next, the writing operation will be explained. A light emission of the laser 18 is pulse-modulated with power higher than that at the time of reading, and the laser beam is emitted to a predetermined position of the optical disc 101. Thereby, the physical characteristics of the irradiated position is changed, so that data is written.

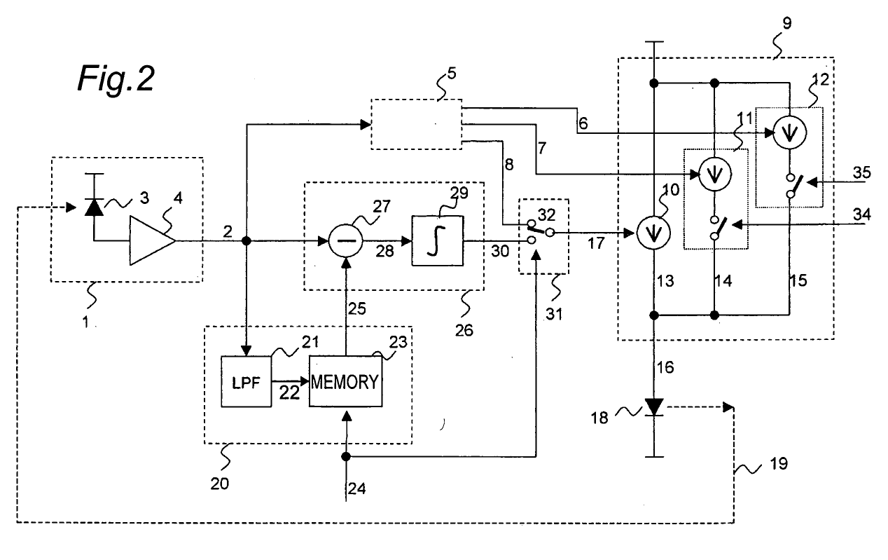

In order to obtain desired laser intensity at any time, this optical disc device performs a laser power control of the feed-back type, which controls the output light intensity to be constant while monitoring the laser emission intensity of the laser 18. The laser power control is carried out by the laser power controller 200. In the laser power controller 200, the laser beam emitted from the laser 18 passes through the collimate lens 102, the transparent mirror 103, and the condenser lens 108, and is received by the power detection means 1. The laser beam received is adjustable by the characteristics of the transparent mirror 103, which can adjust the beam to, for example, 10% of the output light quantity of the laser 18. Further, the laser power of the laser beam received is always in the proportional relationship with the laser power emitted. The laser power controller 200 controls the current amount providing to the laser 18 so that the light intensity of the received laser beam comes to the predetermined intensity. Consequently, the power of the convergence beam 100 emitted proportionately from the object lens 105 can be controlled so as to have the predetermined intensity. The laser power controller 200 will be described in detail below using a block diagram in FIG. 2.

FIG. 2 is a block diagram showing the structure of the laser power controller 200. The laser power controller 200 includes as components, a power detection means 1, an initial value generating means 5, a laser driving means 9, a storing means 20, a computation means 26, a switching means 31, and a laser 18. Each component will be described below.

The power detection means 1 detects light intensity emitted from the laser 18 and generates a monitor waveform 2 of the light intensity. In more detail, the power detection means 1 includes a pin diode 3 and an i/v conversion circuit 4. The pin diode 3 receives the laser beam 19 and detects the emission intensity as current. The i/v conversion circuit 4 converts the output current of the pin diode 3 into a voltage value. Thereby, the monitor waveform 2 can be obtained.

The laser driving means 9 includes a bias current source 10, first pulse current sources 11, and a second pulse current source 12, and drives the laser 18 by using as the driving current the summed current 16 of the output current 13, 14, 15 of each current source. The bias current source 10 controls the current amount corresponding to the output 17 of the switching means 31. The first pulse current source 11 controls the current amount corresponding to the output 7 of the initial value generating means 5, and performs switching corresponding to the record data 34. The second pulse current source 12 controls the current amount corresponding to the output 6 of the initial value generating means 5, and performs switching corresponding to the record data 35.

The storing means 20 includes, a low path filter (LPF) 21 which determines from the pulse-shaped monitor waveform 2 the average value 22 thereof, the monitor waveform 2 appearing when monitoring the pulse-emitting laser beam, and a memory 23 for storing and outputting the average value 22, at the time of a timing signal 24 being input from the outside, as the initial average value 25 of the light intensity of the pulsed emission. The storing means 20 outputs the initial average value 25 of the light intensity of the pulsed emission from the memory 23.

The computing means 26 includes a differential computing unit 27 and an integrator 29. The differential computing unit 27 calculates the difference between the initial average value 25 of the light intensity of the pulsed emission output from the storing means 20 and the monitor waveform 2 output from the i/v conversion circuit 4, and outputs a differential voltage 28. The integrator 29 integrates the differential voltage 28 and outputs an integral value 30.

The initial value generating means 5 outputs a set value 6, 7, 8, of each current source 10, 11, 12, respectively, in the laser driving means 9 on the basis of the monitor waveform 2 obtained by test emitting the laser 18, in order that the laser 18 can emit with the predetermined power. This process will be described later.

The switching means 31 switches, by a switch 32, the output 8 from the initial value generating means 5 and the integral value 30 from the computing means 26, using a timing signal 24 as a trigger, and then supplies as an output 17 to the bias current source 10. In the initial state where the timing signal is not valid, the switch 32 outputs to the bias current source 10 the output 8 from the initial value generating means 5. The initial state means a period from the time that the set value 6, 7, 8 of each current source 10, 11, 12 in the laser driving means 9 is set by the initial value generating means 5, described later, until the initial average value 25 of the light intensity of the pulsed emission of the laser 18 is obtained.

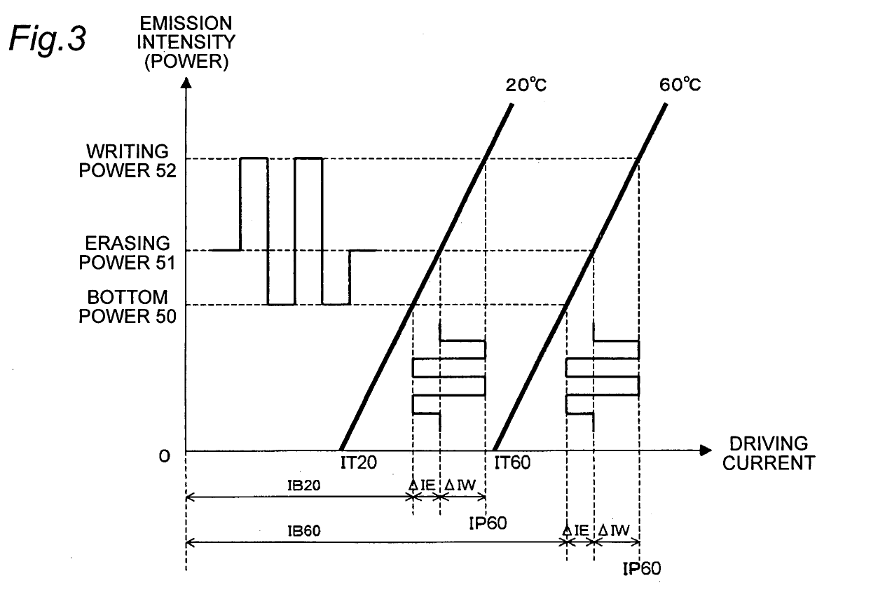

FIG. 3 is a schematic chart showing an operational characteristic of the laser 18. The Abscissa axis shows the driving current of the laser, and the ordinate axis shows the emission intensity of the laser beam. Further, the oblique wide line shows the relationship between the driving current of the laser 18 and the emission intensity. As shown in FIG. 3, the laser has such a characteristic that although a current is applied, it does not emit until the current comes to a threshold, and the emission intensity linearly increases corresponding to the current exceeding the threshold. This chart shows an exemplary characteristic of the laser in which the threshold current varies corresponding to the temperature. Further, as an example of the pulsed emission when data is written into the optical disc, an example of driving the writing pulse with three kinds of power, that is, bottom power 50, erasing power 51, and writing power 52, is shown. Assuming that the temperature of the laser is 20° C., the threshold current is IT20. Thus, it is required to supply to the laser 18 the current IP 20 which is the sum of the bias current IB20 corresponding to the bottom power 50, the first pulse current ΔIE corresponding to the intensity from the bottom power 50 to the erasing power 51, and the second pulse current ΔIW corresponding to the intensity from the erasing power 51 to the writing power 52.

In a case that the temperature of the laser 18 is 60° C., the threshold current increases from IT20 to IT60. Therefore, in order to obtain the same writing power 52, erasing power 51 and the bottom power 50, the bias current must be increased to IB60. On the other hand, the maximum amplitude ΔIE of the first pulse current and the maximum amplitude ΔIW of the second pulse current hardly change from those in the case of 20° C. Therefore, it is required to supply to the laser 18 the current IP60 which is obtained by adding the bias current IB60, which is increased corresponding to the temperature rise, to the maximum amplitude ΔIE of the first pulse current and the maximum amplitude ΔIW of the second pulse current.

Next, the operation of the laser power controller 200 (FIG. 2) according to the embodiment will be explained.

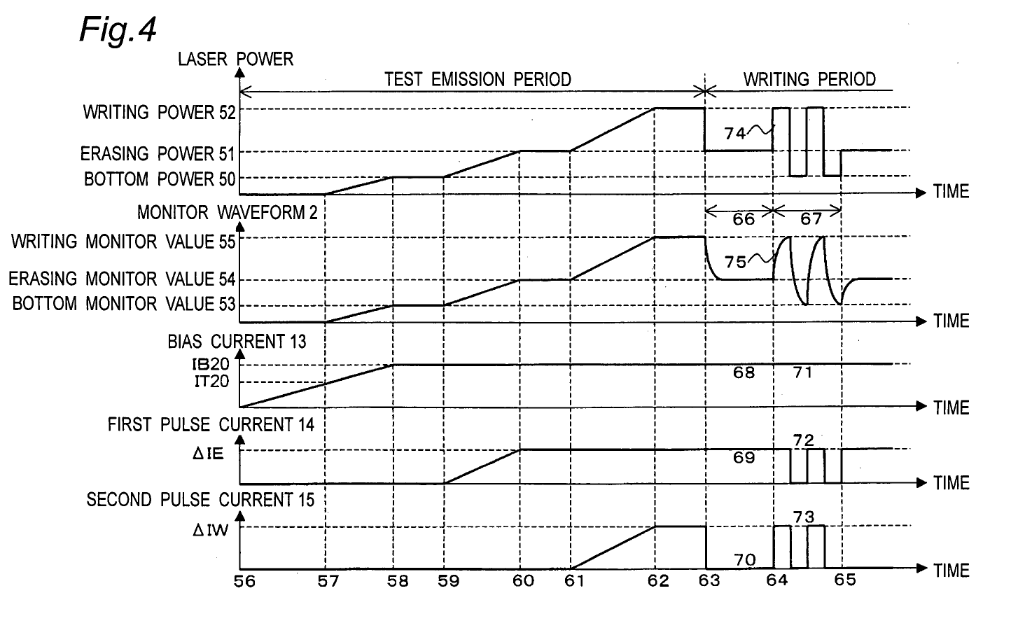

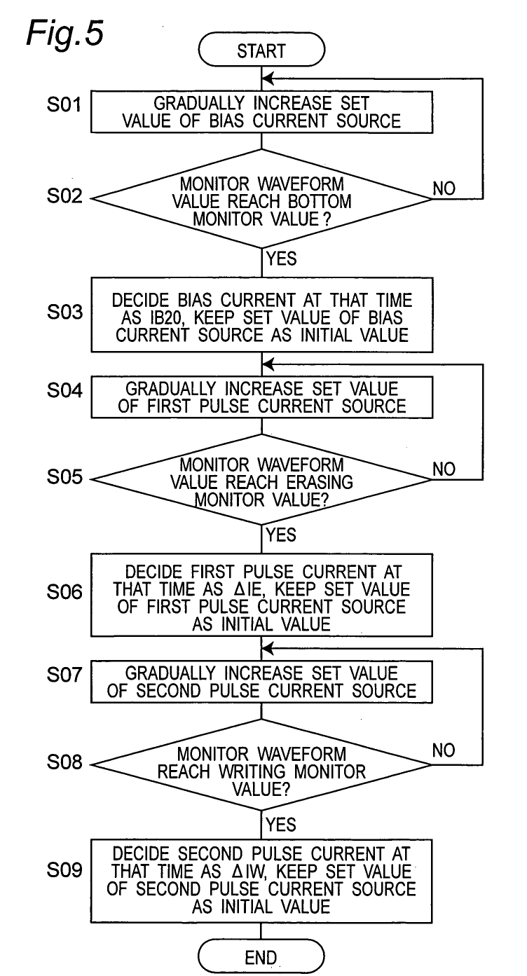

First, a method of determining the initial value (test emission) using the initial value generating means 5 will be explained, referring to FIGS. 4 and 5. FIG. 4 is a signal waveform chart at the time of test-emitting the laser 18. FIG. 5 is a flowchart showing a method of obtaining a set value of each current source by test-emitting the laser 18. More specifically, FIG. 4 represents, waveform charts showing the changes according to time in a bias current 13 output from the bias current source 10, a first pulse current 14 output from the first pulse current source 11, and a second pulse current 15 output from the second pulse current source 12, each of which is in the laser driving means 9, a laser power emitted by the laser 18, and a monitor waveform 2 output from the power detection means 1. During the test emission period, the switches inside the pulse current sources 11 and 12 are turned on due to the record data 34, 35. Further, the temperature of the laser 18 is set at 20° C.

The method of setting the set value 6, 7, 8 of each current source 10, 11, 12 of the laser driving means 9 by test-emitting the laser 18 as shown in FIG. 4, will be explained below, using the flowchart in FIG. 5.

(a) At the initial time 56, any current source does not provide current, so that both of the laser power emitted from the laser 18 and the monitor waveform 2 detected are zero.

(b) When the set value 8 of the bias current source 10 is gradually increased, the bias current 13 increases proportionately (S01). Upon it exceeding the threshold current IT20 at the time 57, the laser 18 starts emitting and the monitor waveform 2 also rises.

(c) The monitor waveform 2 is determined whether it has reached the bottom monitor value 53 (S02).

(d) If the monitor waveform 2 is determined to have reached the bottom monitor value at the time 58, it is determined that the laser power reached the bottom power 50, whereby the bias current 13 at this point is decided as IB20. IB20 at this point is kept as the initial set value 8 of the bias current 10 (S03). If the monitor waveform 2 have not reached the bottom monitor value 53, returning to the former step S01 and further increasing the set value 8 of the bias current 10 gradually.

(e) Next, when the set value 7 of the first pulse current source 11 is gradually increased from the time 59, the first pulse current 14 increases proportionately (S04).

(f) The monitor waveform 2 is determined whether it has reached the erasing monitor value 54 (S05).

(g) If the monitor waveform 2 is determined to have reached the erasing monitor value 54 at the time 60, it is determined that the laser power reached the erasing power 51, whereby the first pulse current 14 at this point is decided as ΔIE. ΔIE at this point is kept as the initial set value 7 of the amplitude of the first pulse current source 11 (S06). If the monitor waveform 2 have not reached the erasing monitor value 54, returning to the former step S04, and further increasing the set value 7 of the first pulse current source 11 gradually.

(h) When the set value 6 of the second pulse current source 12 is gradually increased from the time 61, the second pulse current 15 increases proportionately (S07).

(i) The monitor waveform 2 is determined whether it has reached the writing monitor value 55 (S08).

(j) If the monitor waveform 2 is determined to have reached the writing monitor value 55 at the time 62, it is determined that the laser power reached the writing power 52, whereby the second pulse current 15 at this point is decided as ΔIW. ΔIW at this point is kept as the initial set value 6 of the amplitude of the second pulse current source 12 (S09). If the monitor waveform 2 have not reached the writing monitor value 55, returning to the former step S07, and further increasing the set value 6 of the second pulse current source 12 gradually.

(k) The test emission for deciding the initial values ends at the time 63.

It should be noted that in the present embodiment, the operation of the initial value generating means is explained with a view of the test emission, but it is not limited to this method. For example, the initial value of each current source may be decided while extracting the part of the writing pulse with the high-speed sample and holding method, like the conventional technique. Alternatively, performing a test writing into the optical disc while actually varying the laser current, and the writing current, at the time that the desired reading characteristic is obtained, may be decided as the initial value.

Next, pulsed emission by the laser 18 when writing will be explained. In FIG. 4, writing of data into the optical disc starts at the time 63 where the test emission ends. For writing, there are required two kinds of sections, that is, a space section 66 during which the erasing power 51 from the time 63 to the time 64 is sustained as the laser power, and a mark section 67 during which the laser power is modulated in high speed between the writing power 52 and the bottom power 50 from the time 64 to the time 65. Therefore, in the laser power controller 200 in FIG. 2, the initial set values 6, 7, 8, decided through the test emission in the initial value generating means 5, are input in the laser driving means 9, and while the laser 18 is driven with the summed current 16 of the output of each current source, switching is performed between the first pulse current source 11 and the second pulse current source 12 corresponding to the record data 34, 35. More specifically, during the space section 66, the summed current of the bias current 68 and the first pulse current is supplied to the laser 18. At this time, the second pulse current 70 is turned off due to the record data 34. On the other hand, during the mark section 67, the summed current of the bias current 71, the first pulse current 72 and the second pulse current 73 is supplied to the laser 18. At this time, the first pulse current 72 is modulated at high speed by the record data 34, and the second pulse current 73 is modulated at high speed by the record data 35.

Now, a waveform response in the power detection means 1 in FIG. 2 will be complementary explained. Since the pin diode 3 has a capacity between terminals, the response frequency characteristic is bandwidth-limited in the combination with the i/v conversion circuit 4. Consequently, even when the waveform 7 of the emitted pulse of the laser 18 rises at high speed, the monitor waveform 75 cannot track the pulse waveform 74 so as to be in an obtuse shape, as shown in FIG. 4. Therefore, although the waveform correctly responds to a gentle power change like test emission, the power of the high-speed emitted pulse cannot be detected correctly.

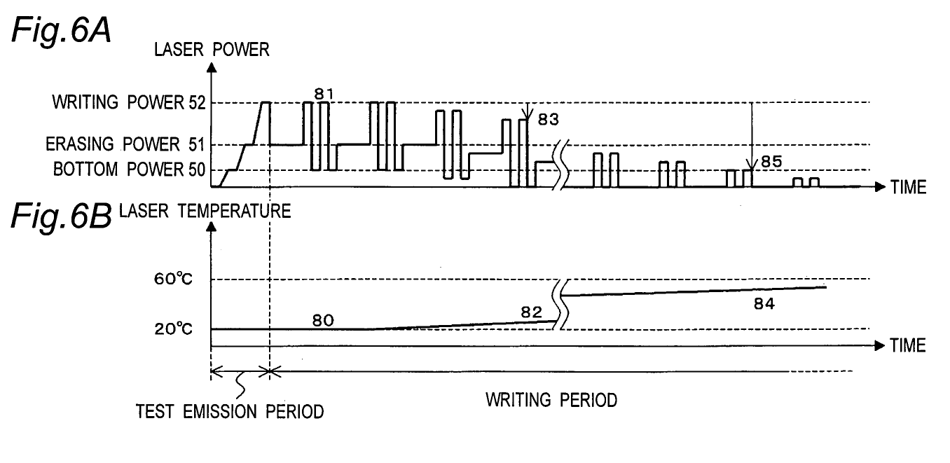

FIGS. 6A and 6B show an example in which the temperature of the laser 18 rises and the laser power drops in a case of not applying the laser power controlling method of the present invention. The abscissa axis shows the elapsed time, and as for the ordinate axes, FIG. 6A shows the changes of the laser power, and FIG. 6B shows the changes of the temperature of the laser 18. Note that the time shown by the abscissa axis takes considerably longer than that in FIG. 4. As explanation will be given for a case of shifting from the test emission to writing, and continuing the writing. The laser temperature 80 right after the test emission is 20°, and the laser power 81 is correct. However, as time goes by, the laser temperature 82 rises gradually due to the current temperature loss flowing through the laser 18 itself, as shown in FIGS. 6A and 6B. In the laser 18 having the characteristic shown in FIG. 3, the laser power 83 drops corresponding to the temperature rise. Then, when the laser temperature 84 rises, for example, to near 60° C., the drop in the laser power 85 becomes large enough not to be disregarded. In this state, data cannot be correctly written into the optical disc. However, with the laser power controlling method of the present invention explained below, it is possible to avoid the drop in the laser power.

The principle of the laser power controlling method according to the present invention will be explained. The change in terms of time in the laser power fluctuation due to the temperature change is very gentle. Further, referring to the change in the temperature characteristic shown in FIG. 3, the inclination showing the rise in the laser power with reference to the driving current is considered to be almost constant, irrespective of the temperature. In order to control the laser power to be constant with reference to the temperature change, it is understood that only the bias current should be controlled, while the first pulse current and the second pulse current are fixed since they hardly change. Further, the change in the laser power can be detected as an integral for change of the laser power (light intensity) of the pulsed emission, without extracting each part of the pulsed emission correctly by the monitor waveform. Moreover, in the data to be written in the optical disc, the average value in terms of time of the low-pass component is almost constantly coded so as to stabilize the focus or the tracking servo, generally. Therefore, with a closed-loop control below the bandwidth of the low-pass fluctuation of the record data, it is possible to continuously control the laser power using the average value of the light intensity of the pulsed emission described above even when the pulsed emission for writing is performed, without using a sample and hold circuit which extracts at high speed the flat portion of the pulse.

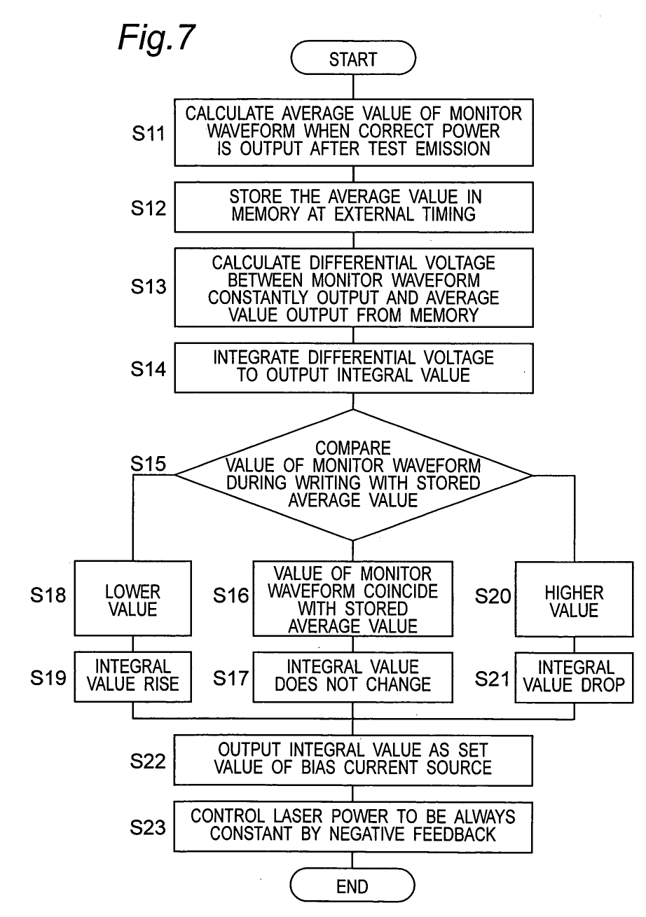

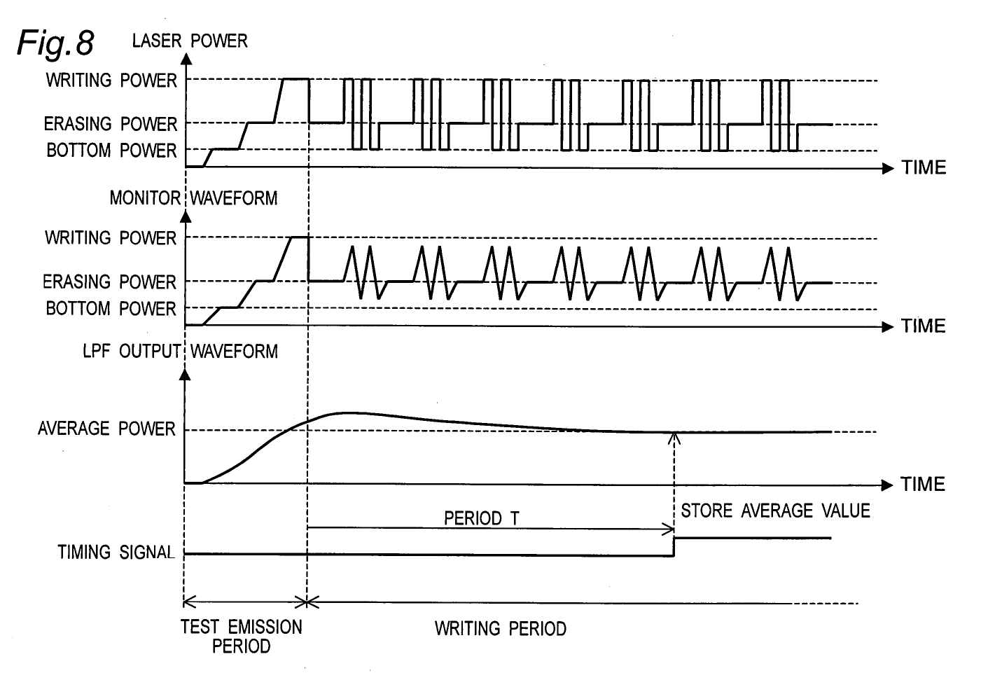

The laser power controlling method according to the embodiment of the present invention will be explained below referring to FIGS. 7 and 8. FIG. 7 is a flowchart showing the laser power controlling method. FIG. 8 is a signal waveform chart showing the timing where the initial average value of the light intensity of the pulsed emission is obtained.

(a) In order to obtain a driving current required for pulse-driving the laser, driving current required for bottom power, erasing power, and writing power is obtained by detecting a monitor waveform of the laser power corresponding to the current, within the test emission period. Then, using the current value, the laser starts to emit the pulsed emission to write.

(b) Within the period in which the correct laser power right after the test emission is outputting, the average value 22 of the monitor waveform 2 of the light intensity of the pulsed emission is obtained by the low-pass filter 21 in the storing means 20 of the laser power controller 200 (S11). Since the pulsed emission during the writing period is performed at considerably high speed, an accurate waveform corresponding to the writing power or the bottom power cannot be obtained with the monitor waveform 2. The average power of the writing pulse, that is the average value of the light intensity of the monitor waveform is obtained by the low-pass filter (LPF). As another method for obtaining the average value, a mathematical average computation for each unit time may be used.

(c) Following the period T, a predetermined timing signal 24 is input from the outside, and the average value 22 at that time is stored in the memory 23 as the initial average value 25 of the light intensity of the pulsed emission (S12). If the period T, until the timing signal is input, is a short period from the time that the correct relationship between the driving current and the laser power is obtained through the test emission or the like, in which the temperature change of the laser itself can be disregarded, the correct average value of the laser power can be obtained before the laser power changes. On the other hand, the period must be longer than the time period until the average value of the LPF output is converged. Practically, the period T is preferably about 10 μs. Further, after the timing signal 24 is input from the outside, the initial average value 25 of the light intensity of the pulsed emission is output from the memory 23. From now on, the laser power control is carried out using the initial average value 25 as the basis value. It should be noted that although the memory 23 may be composed of an analog sample and hold circuit of relatively low-speed, it can be easily realized by a register or the like, if digital.

(d) Next, a differential voltage 28 between the monitor waveform 2 constantly output and the average value 25 output from the storing means 20 is obtained by the differential computing unit 27 in the computing means 26 (S13).

(e) The differential voltage 28 is temporally integrated by the integrator 29, and the integral value 30 is output (S14). The monitor waveform 2 during writing shows a constant alternating waveform.

(f) The waveform of the monitor waveform 2 during writing and the initial average value 25 stored are compared (S15).

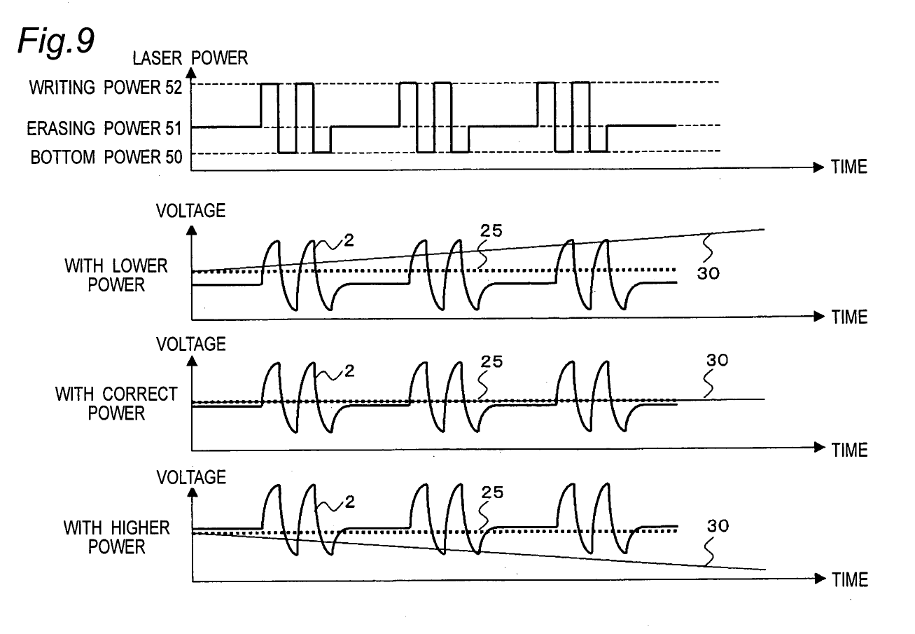

(g) Corresponding to the result of comparing the waveform of the monitor waveform 2 during writing with the initial average value 25 stored, the operation is changed as follows, as shown in FIG. 9. FIG. 9 shows an example where a feedback control is not performed.

1) If the value of the monitor waveform 2 at that time and the average value 25 stored coincide with each other (S16), the laser power is considered to be correct, whereby the integral value 30 does not change (S17).

2) If the value of the monitor waveform is lower (S18), the laser power is considered to be lower than the normal value, whereby the integral value 30 rises (S19).

3) In contrast, if the value of the monitor waveform is higher (S20), the laser power is considered to be higher than the normal value, whereby the integral value 30 drops (S21).

(h) The integral value 30 is output as a set value 17 of the bias current source 10 (S22). Note that after the timing signal 24 is input, the switch 32 in the switching means 31 is switched, whereby the integral value 30 is output as the set value 17 of the bias current source 10, instead of the initial value 8.

(i) Thereby, a negative feedback is applied to the laser power (S23). In other words, when the laser power rises due to the temperature change, the bias current is decreased whereby the laser power is weakened. In contrast, when the laser power drops, the bias current is increased whereby the laser power is intensified. Thereby, even though the laser temperature changes during a data writing unit of several 100 μs to several 10 ms, required current is automatically corrected, so that the power is controlled to be constant.

As described above, the integral value 30 of the differential voltage between the value of the monitor waveform and the initial average value 25 stored is set as a set value 17 of the bias current source, whereby the feedback control can be performed so that the laser power is constant at any time. Note that the appropriate point of validating the timing signal 24 is right after the test emission with the right power.

In the aforementioned embodiment, the exemplary explanation has been given for the case that the laser power controller of the present invention is used in the optical disc device. However, the present invention is not limited to be used in the optical disc device, and can be used in a laser printer or in an optical. monitor of a laser for communications where a laser light source must be controlled.

Although the present invention has been described in connection With the preferred embodiments thereof with reference to the accompanying drawings, it is to be noted that various changes and modifications are apparent to those skilled in the art. Such changes and modifications are to be understood as included within the scope of the present invention as defined by the appended claims, unless they depart therefrom.

The present disclosure relates to subject matter contained in Japanese Application No. 2003-103946, filed on Apr. 8, 2003, the contents of which are herein expressly incorporated by reference in its entirety.

What is claimed is:

1. A laser power controlling method comprising the steps of:
calculating an initial average value of a light intensity of a pulsed emission of a laser;
calculating a value of the light intensity of the pulsed emission of the laser for each time, and calculating a difference between the value and the initial average value; and
controlling a driving current of the laser according to the difference.

2. The laser power controlling method according to claim 1, wherein the step of calculating the initial average value of the light intensity of the pulsed emission of the laser comprises the steps of:
providing a predetermined driving current with the laser so as to cause a pulsed emission;
receiving the pulsed emission of the laser, and detecting the light intensity; and
averaging the light intensity, and calculating the initial average value of the light intensity of the pulsed emission.

3. The laser power controlling method according to claim 2, wherein the step of controlling the driving current of the laser comprises the steps of:
temporally integrating the difference, and outputting an integral value; and
providing the driving current obtained by summing the predetermined driving current and a compensation current corresponding to the integral value.

4. The laser power controlling method according to claim 2, wherein in the step of providing the predetermined driving current with the laser so as to cause the pulsed emission, the pulsed emission is caused by applying the driving current obtained by summing a pulse current in which an intensity thereof is modulated, and a bias current having a constant current value.

5. The laser power controlling method according to claim 4, wherein the compensation current is a current for adjusting the bias current.

6. The laser power controlling method according to claim 1, further comprising a step of setting the predetermined driving current for pulse-emitting the laser.

7. The laser power controlling method according to claim 6, wherein the step of setting the predetermined driving current comprises the steps of:
providing a current with the laser in a predetermined test emission pattern;
receiving a laser emission of the laser, and detecting a light intensity thereof; and
setting an initial value of a current source of the predetermined driving current according to a current value where the light intensity comes to a predetermined monitor value.

8. A laser power controller comprising:
a laser driving unit which applies a driving current to a laser for causing a pulsed emission on the laser;
a light receiving unit which receives the pulsed emission of the laser and detecting the light intensity thereof for each time;
an initial average value calculating unit which calculates an initial average value of the light intensity of the pulsed emission of the laser;
a computing unit which calculates a difference between the value of the light intensity for each time and the initial average value; and
a control unit which controls the driving current according to the difference.

9. The laser power controller according to claim 8, wherein the initial average value calculating unit provides a predetermined driving current from the laser driving unit to the laser so as to cause a pulsed emission, receives the pulsed emission of the laser in the light receiving unit so as to detect the light intensity, and averages the light intensities so as to calculate the initial average value of the light intensity of the pulsed emission.

10. The laser power controller according to claim 8, wherein the control unit temporally integrates the difference and outputs an integral value, and provides with the laser a driving current obtained by summing the predetermined driving current and a compensation current corresponding to the integral value so as to control the driving current.

11. The laser power controller according to claim 8, wherein the laser driving unit comprises:
a bias current source; and
a pulse current source which outputs a pulse current in which an intensity thereof is modulated.

12. The laser power controller according to claim 8, further comprising, a driving current setting unit which sets the predetermined driving current for causing the pulsed emission of the laser.
